(19) United States
(12) Patent Application Publication
(10) Pub. No.: US 2009/0040265 A1
(43) Pub. Date: Feb. 12, 2009

(54) INK STORING BOX

(75) Inventors: Min-Hsi Liu, Hsinchu (TW); Wei-Fong Lin, Hsinchu (TW); Wei-Yuan Peng, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: FOXLINK IMAGE TECHNOLOGY CO., LTD., Hsinchu (TW)

(21) Appl. No.: 11/834,142

(22) Filed: Aug. 6, 2007

(51) Int. Cl. B41J 2/165

(52) U.S. Cl. 347/29

(57) ABSTRACT

An ink-storing box includes a container, a cover covering on the container and a lock gate. The cover defines at least one communicating hole therein. The lock gate includes a base board movable arranged between the cover and the container and a drive portion located on the base board, the base board defining a cooperation hole therein. The lock gate is set between the cover and the container for allowing the hole of the cover communicating with the interior of the container or shielding the interior of the container from being exposed through the hole of the cover. Thereby the ink-storing box of the present invention can receive the ink jetted from the ink box and prevent the evaporation of the ink.

### BACKGROUND OF THE INVENTION

1. Field of the Invention

The present invention relates to an ink-storing box, and more particularly to an ink-storing box used in a maintenance station of a business machine or an inkjet printer.

2. The Related Art

When a business machine or an inkjet printer works, the ink box usually preheats and tries to jet ink, the business machine or the inkjet printer usually sets a maintenance station to receive the ink jetted from the jet head and scrape the ink remained thereat, more specifically, an ink-storing box is arranged in the maintenance station to receive the ink jetted from the ink box.

Please refer to FIG. 1, a conventional ink-storing box 4 is shown. The conventional ink-storing box 4 includes a container 40 for receiving the ink and a cover 50 covering on the container 40, two holes 510 are defined in the cover 50 for allowing the ink jetted from the jet head passing therethrough.

However, the ink is easy to evaporate from the hole 510 of the ink-storing box 4. When a lot of ink is evaporated, it affects the inkjet printer or the business machine, for example, it leads to abnormal action of the inkjet printer or the business machine. Usually, the quality of the printing will reduce.

### SUMMARY OF THE INVENTION

Accordingly, an object of the present invention is to provide an ink-storing box includes a container, a cover covering on the container and a lock gate. The container is used for receiving the ink and has a bottom board, and a set of side boards extending upward from edges of the bottom board. The cover defines at least one hole through the cover. The lock gate has a base board movable arranged between the cover and the container and a drive portion located on the base board. The base board defines a cooperation hole therethrough for communicating with the hole of the cover or shielded by the cover.

As described above, the lock gate is set between the cover and the container for allowing the hole of the cover communicating with the interior of the container or shielding the interior of the container from being exposed through the hole of the cover, thereby, the ink-storing box of the present invention can not only receive the ink jetted from the ink box but also prevent the evaporating of the ink, so the effect that caused by evaporated ink is avoid, the inkjet printer or the multi-functional business machine will work smoothly and the quality of printing is good.

### BRIEF DESCRIPTION OF THE DRAWINGS

The present invention will be apparent to those skilled in the art by reading the following description of a preferred embodiment thereof, with reference to the attached drawings, in which:

FIG. 1 shows a conventional ink-storing box;

FIG. 2 is a perspective view of an ink-storing box of the present invention;

FIG. 3 is a perspective view of the ink-storing box of the present invention viewing from another angle;

FIG. 4 is an exploded view of the ink-storing box of the present invention;

FIG. 5 is a perspective view of a lock gate of the ink-storing box of the present invention;

FIG. 6 is a vertical view of the ink-storing box of the present invention;

FIG. 7 is a cross-sectional view taking along line VII-VII shown in FIG. 6.

FIG. 8 is a vertical view of the ink-storing box with the lock gate being drawn apart; and

FIG. 9 is a cross-sectional view taking along line IX-IX shown in FIG. 8.

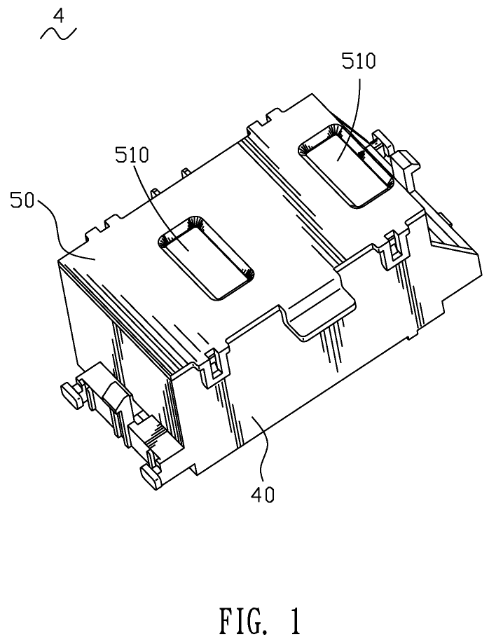

### DETAILED DESCRIPTION OF THE PREFERRED EMBODIMENT

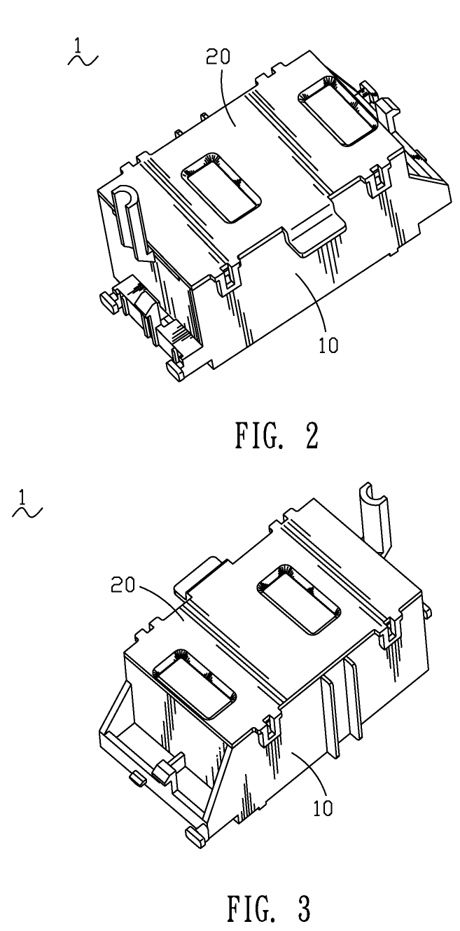

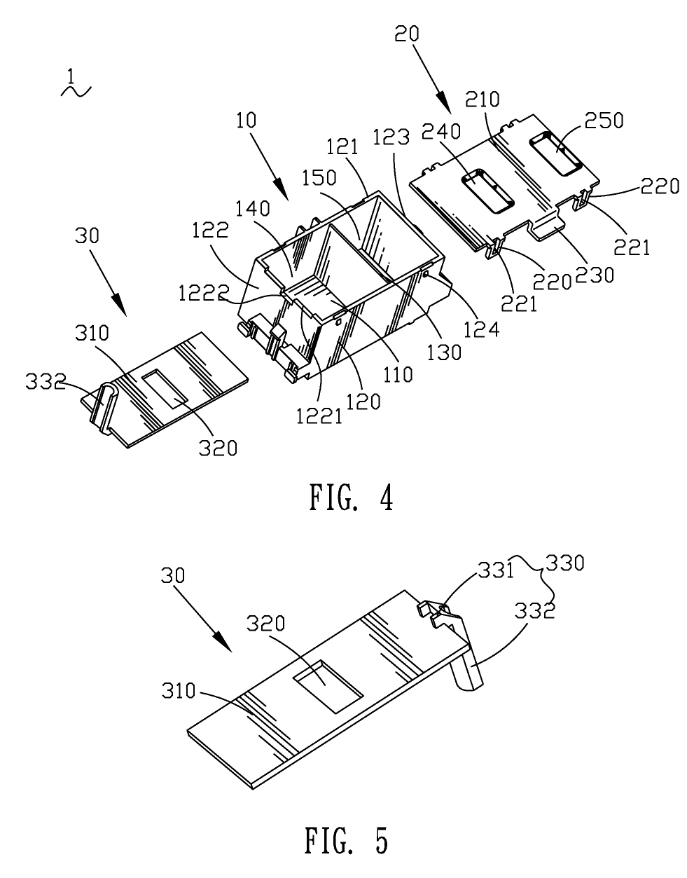

Please refer to FIGS. 2-3, an ink-storing box 1 of the present invention is arranged in a maintenance station for receiving the ink jetted from the ink box of a multi-functional business machine or an inkjet printer. The ink-storing box 1 includes a container 10, a cover 20 covering on the container 10 and a lock gate 30 located between the container 10 and the cover 20 (shown in FIG. 4).

Please refer to FIG. 4, the container 10 is approximately rectangle-shaped and has a bottom board 110. The four sides of the bottom board 110 extend upward to form a front board 120, a back board 121, a left board 122 and a right board 123. A location mechanism (not shown) is set beside the container 10 to locate the container 10 on the maintenance station. A protuberance 124 projects from two ends of upper portions of the front board 120 and the back board 121 respectively. A first opening 1221 is defined at the top of the left board 122, a second opening 1222 is defined at the middle of the bottom of the first opening 1221. The central part of the interior of the container 10 sets a partition 130 connecting with the bottom board 110, the front board 120 and the back board 121, the height of the partition 130 is equal to the height of the bottom of the first opening 1221, the partition 130 separates the interior of the container 10 into a first space 140 and a second space 150 for receiving ink.

The cover 20 has a rectangular top board 210, two ends of the front edge and the back edge of the cover 20 extend downward to form an engage piece 220 respectively. An engage hole 221 is defined in the engage piece 220 for engaging with the protuberance 124 of the front board 120 and then positioning the cover 20 on the container 10. The middle portion of the front edge of the top board 210 extends downwards and vertically, and then further extends frontward and vertically to form a wing board 230 for guiding the cover 20 taking apart from the container 10. The top board 210 has a rectangular first hole 240 through the top board 210 arranged at the left side and a second hole 250 arranged at the right side and paralleling to the first hole 240. When the cover 20 covers on the container 10, the first hole 240 communicates with the first space 140 and the second hole 250 communicates with the second space 150.

Please refer to FIG. 4 and FIG. 5, the lock gate 30 includes a rectangular base board 310 having a cooperation hole 320 thereon, the size of the cooperation hole 320 is the same as that of the first hole 240 and the second hole 250. The middle of the left edge of the base board 310 locates a drive portion 330 vertical to the base board 310. The drive portion 330 includes a support projection 331 protruding from the bottom of the base board 310 and a half cylinder-shaped drive shaft 332 extending upward from the outer end of the support projection 331 and vertical to the base board 310, the drive shaft 332 is positioned on a frame of the ink-storing box (not shown).

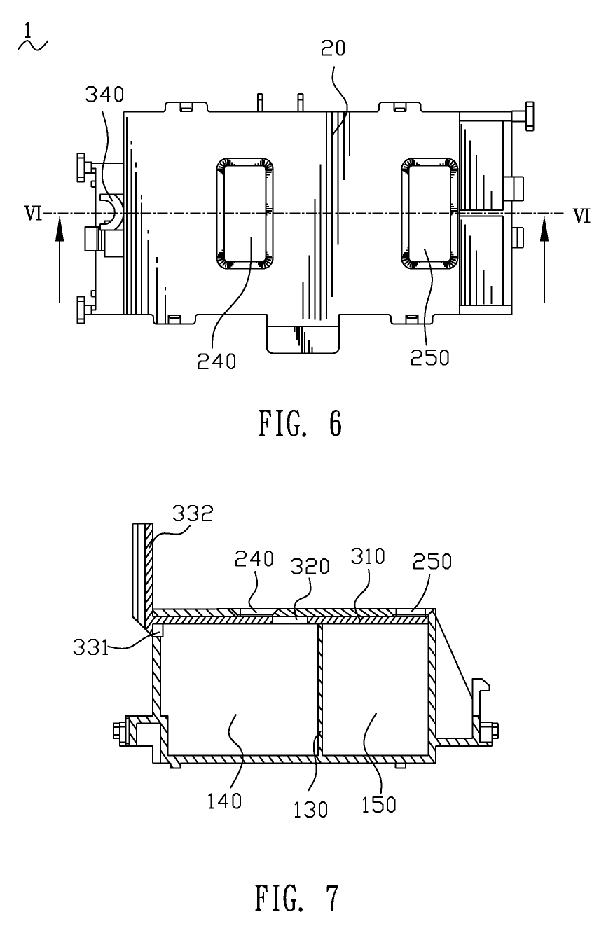

Referring to FIGS. 6-7 in combination with FIG. 2, the base board 310 of the lock gate 31 is inserted into the ink-storing box 1 from the first opening 1221 and is placed on the partition 130, the support projection 331 is embedded in the second opening 1222. In this situation, the cooperation hole 320 of the base board 310 is between the first hole 240 and the second hole 250, the base board 310 shields the first space 140 and the second space 150 from being exposed through the first hole 240 and the second hole 250, as a result, the ink received in the container 10 won't evaporate from the first hole 240 and the second hole 250.

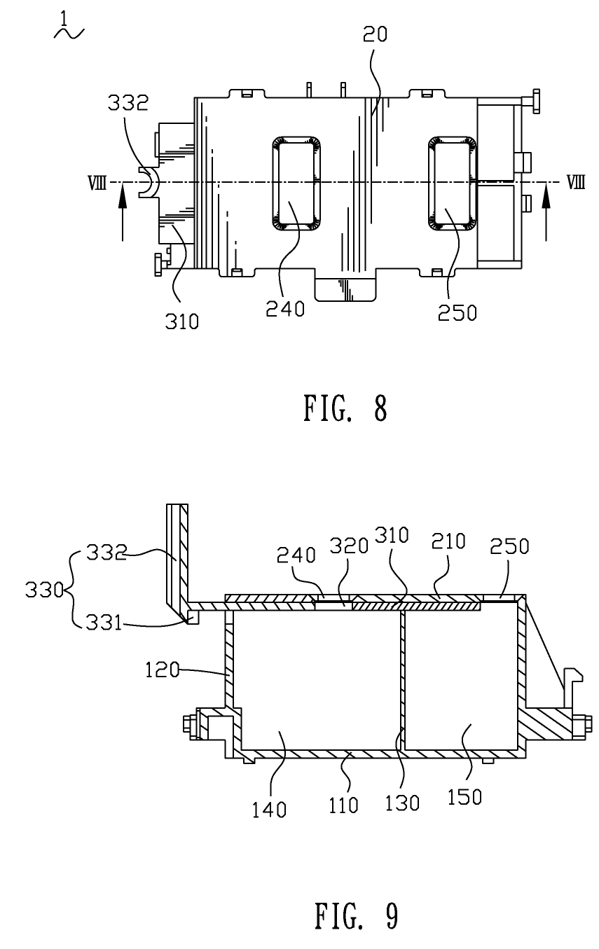

Then please refer to FIG. 8 and FIG. 9, the drive shaft 332 of the lock gate 30 is pulling out of the base board 310 under the action of the frame of the ink-storing box, when the cooperation hole 320 of the base board 310 matches the first hole 240, the right edge of the base board 310 is between the first hole 240 and the second hole 250, in this situation, the first hole 240 and the second hole 250 both communicate with the container 10 for receiving the ink jetted from the ink box.

As described above, the lock gate 30 is set between the cover 20 and the container 10 for allowing the first hole 240 and the second hole 250 communicating with the first space 140 and the second space 150 respectively or shielding the first space 140 and the second space 150 from being exposed through the first hole 240 and the second hole 250, thereby, the ink-storing box 1 of the present invention can not only receive the ink jetted from the ink box but also prevent the evaporating of the ink, so the effect that caused by evaporated ink is avoid, the inkjet printer or the multi-functional business machine will work smoothly and the quality of printing is good.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An ink-storing box, comprising:
a container for receiving the ink, having a bottom board, and a set of side boards extending upward from edges of the bottom board;
a cover covering on the container, the cover defining at least one hole through the cover; and
a lock gate, having a base board movable arranged between the cover and the container and a drive portion located on the base board, the base board defining a cooperation hole therethrough for communicating with the hole of the cover or shielded by the cover.

2. The ink-storing box as claimed in claim 1, wherein the cover defines two holes, when the base board is placed between the cover and the container enough, the cooperation hole of the base board is between the two holes of the cover, when the base board is pulled out, the cooperation hole of the base board matches with one of the two holes of the cover and the other holes of the cover communicates with the interior of the container.

3. The ink-storing box as claimed in claim 1, wherein the set of side boards has a left board, a first opening is defined at the top of the left board, the base board of the lock gate is inserted into the ink-storing box from the first opening.

4. The ink-storing box as claimed in claim 3, wherein the interior of the container sets a partition, the height of the partition is equal to the height of the bottom of the first opening, the partition separates the interior of the container into a first space and a second space.

5. The ink-storing box as claimed in claim 1, wherein the drive portion includes a support projection protruding from the bottom of the left board of the base board and a half cylinder-shaped drive shaft extending upward from the outer end of the support projection, the bottom of the first opening defines a second opening at the middle for embedding the supporting projection.
